(19) United States
(12) Patent Application Publication
(10) Pub. No.: US 2019/0220522 A1
(43) Pub. Date: Jul. 18, 2019

(54) Computer System and Method of Exchanging Information

(71) Applicant: Immagonna Inc., Tempe, AZ (US)

(72) Inventors: Jonathan Yu, Tempe, AZ (US); Arthur Yu, Tempe, AZ (US)

(73) Assignee: Immagonna Inc., Tempe, AZ (US)

(21) Appl. No.: 15/873,037

(22) Filed: Jan. 17, 2018

(51) Int. Cl. G06F 17/30

(52) U.S. Cl. CPC G06F 17/3043; G06F 17/3089

(57) ABSTRACT

An electronic network is provided to facilitate an exchange of information. A database on a first computing system provides a data structure to organize records for the exchange of information. A request for information is sent from a first user on a second computing system to the electronic information exchange agent and stored in the data structure. The request for information has an offer of compensation for a response to the request for information. The response to the request for information is sent from a second user on a third computing system to the electronic information exchange agent and stored in the data structure. The first user has an acceptance option or rejection option and a feedback option to evaluate the response to the request for information. A portion of the compensation is reserved as an administrative fee for use of the electronic information exchange agent.

### FIELD OF THE INVENTION

The present invention relates in general to an enhanced computer system and, more particularly, to information exchange through the enhanced computer system.

### BACKGROUND OF THE INVENTION

A computer system provides an opportunity to share and exchange information. The availability and access to information continue to expand with higher bandwidth internet, more storage space, mobile devices, and faster computing platforms. People routinely have questions on many topics and often turn to a computer to find an answer. Consider a situation where a user has a question, e.g., how to determine the best type and schedule for lawn fertilizer, or how to stream video, or how to properly cast when fly fishing, or how to start a business selling antique furniture.

The internet has many websites dedicated to certain topics. There are websites dedicated to yard care, to video streaming, to fly fishing, and so on. Each website often includes a blog or chat room for the users to communicate. Within a blog or chat room of a particular website, a user or requester can ask a question in written text form, see above examples. The requesting user posts the question and waits and hopes for an answer. If the question is interesting, or the other responding users have the time and inclination, the question may get a response. Indeed, the requesting user may get multiple responses from different users. The difficulty arises when the response may not properly address the question, possibly because the original question was vague or ambiguous, or the responding user provides an incomplete, inaccurate, or biased response without the proper knowledge base. The requesting user may ask for clarification or provide additional detail of the question. The responding user provides more information that may or may not be helpful. Many such scenarios devolve into a continuing back and forth that never resolves the issue or answers the question. The requesting user may say “tried that and did not work”, the responding user may say “don't know, worked for me.” The exchange does not address the issue. In other patterns, multiple responding users may disagree with each other, leading to open debates within the blog or chat room. The requesting user only gets more confused by the many differences in opinion.

A fundamental problem with the blog or chat room is that anyone can respond or comment, with or without relevant knowledge and experience. The requesting user often receives opinions, speculation, and guesses because of the nature of the source. The responses are free, with no historical and objective feedback on individual responding users, so there is little or no expectation or accountability for true and accurate information. Accordingly, the adhoc approach to the information exchange places a burden on the computer systems. The information is disorganized, inaccurate, and does not permit efficient operation of the computer systems. The computer system does not function in an optimal manner relative to information exchange.

If the requester cannot get answers from the blog or chat room, he or she may try asking another person directly, e.g., salesperson in a retail store, or a friend of a friend at social gathering. The result is often the same. The salesperson may be biased and provide an answer that leads the requester toward purchasing a product or service of the store. The salesperson is often primarily motivated by the commission of the sale. The requester is not paying for an answer, but rather is paying for a product or service of the store. The friend of a friend may not have the requisite knowledge or experience on topic and yet still provides an answer in an attempt to be helpful or simply to maintain appearances. The requester should understand that the response may be mere opinion, speculation, or guesswork. Again, the response is a non-compensated courtesy, with no historical and objective feedback on the responding person, so there is little or no expectation or accountability for true and accurate information.

The requester may hire a professional or consultant to assist with the question. The requester meets with or otherwise discusses the matter with the professional or consultant. Some research may be required to provide a response. Assuming the professional does not have a hidden agenda, i.e., to sell another product or service, the requester may indeed receive true and accurate information as there is a level of expectation and accountability with private paid consultation. However, the approach is extreme for many questions and often cost prohibitive. Most requesters cannot afford to extend such a high cost for an answer to each question that arises in daily activities.

So the problem remains: how to get information on a given topic with confidence that the response is complete, true, and accurate for a reasonable cost. The requester may indeed be willing to compensate the responder, but desires to pay for the answer, not for collateral products or services.

### BRIEF DESCRIPTION OF THE DRAWINGS

FIG. 1 illustrates an electronic information exchange agent handling information exchange between requesters and providers;

FIG. 2 illustrates a data structure for the information exchange transaction;

FIG. 3 illustrates an electronic communication network connecting users and devices;

FIG. 4 illustrates computer systems operating on the electronic communication network;

FIG. 5 illustrates an account and profile webpage for users to set up with the information exchange agent;

FIG. 6 illustrates a home webpage for the information exchange agent with first level features;

FIG. 7 illustrates a webpage for entering a request for information with the information exchange agent;

FIG. 8 illustrates a flowchart of an information exchange transaction;

FIG. 9 illustrates a webpage of a provider profile and other information related to the provider;

FIG. 10 illustrates a webpage showing a response to the request for information;

FIG. 11 illustrates disbursement of funds to the provider for the response to the request for information;

FIG. 12 illustrates a webpage for entering feedback about the provider and response to the request for information;

FIG. 13 illustrates a webpage for asking a question of a specific person, organization, entity, or group;

FIGS. 14a-14b illustrate an alternative webpage for asking a question of a specific person, organization, entity, or group;

FIG. 15 illustrates a webpage for entering specific information for the question of a specific person, organization, entity, or group;

FIG. 16 illustrates a webpage for listing various information exchange transactions;

FIG. 17 illustrates further detail of a particular information exchange transaction;

FIG. 18 illustrates a webpage for making a stake in an information exchange transaction;

FIG. 19 illustrates multiple providers responding to a request for information;

FIG. 20 illustrates a knock feature for an information exchange transaction;

FIGS. 21a-21b illustrate conducting a session from the knock;

FIG. 22 illustrates creating a session without prior request;

FIG. 23 illustrates a do listing of personal information exchange transactions;

FIGS. 24a-24c illustrate a business sponsoring an information exchange transaction; and

FIG. 25 illustrates a business sponsoring a stake in an information exchange transaction.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

People regularly engage in the exchange of information. The continuing flow of accurate and useful information is a principal way to efficiently solve problems, learn, and advance personal objectives. A computer system provides an opportunity to share and exchange information. The availability and access to information continue to expand with higher bandwidth internet, more storage space, mobile devices, and faster computing platforms. People routinely have questions on many topics and often turn to a computer to find an answer. However, as discussed in the background, the adhoc approach to the information exchange places a burden on the computer systems. The information is disorganized, inaccurate, and does not permit efficient operation of the computer systems. The computer system does not function in an optimal manner relative to information exchange.

An enhanced computer system with associated data and organizational structures would monitor and regulate the connection between users seeking to exchange information. The requesting user would ask a direct, specific, and unambiguous question. The responding user would have relevant knowledge and experience on topic. The responses are compensated, with historical and objective feedback on individual responding users, so there is an expectation or accountability for true and accurate information.

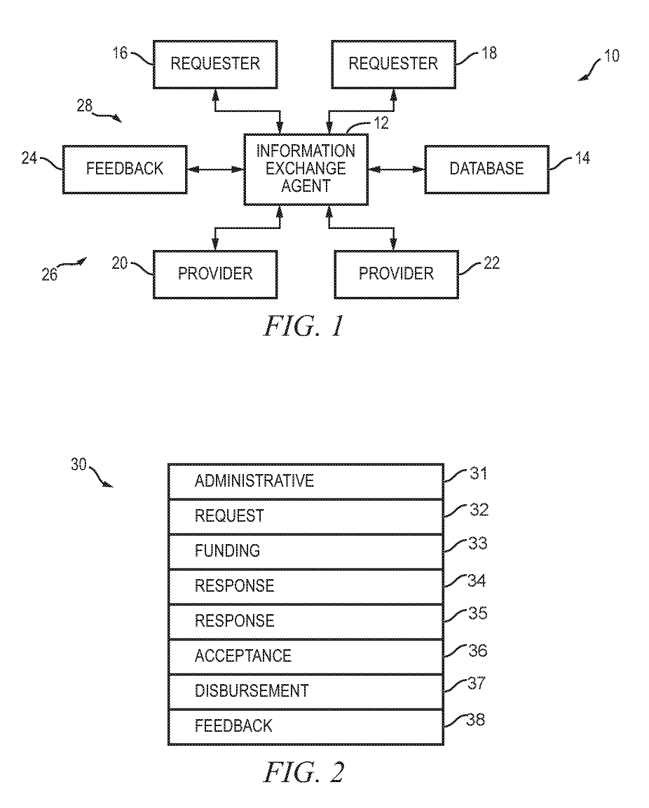

FIG. 1 shows an enhanced computer system 10 with electronic information exchange agent 12 maintaining database 14. Database 14 is a mass storage system, e.g., server mass storage, with a data structure and record organization optimized for exchange of information between users. Requesters 16 and 18 are users with a question or inquiry made to electronic information exchange agent 12. Requester 16 or 18 makes a request for someone knowledgeable on the subject to provide a response or answer to the question. Provider 20 is a person with specific knowledge and experience relevant to the topic question or inquiry proposed by requester 16. Likewise, provider 22 is another person with specific knowledge and experience relevant to the topic question or inquiry proposed by requester 16 or 18. Electronic information exchange agent 12 functions as an organizer and facilitator between requester 16 or 18 and provider 20 or 22 (collectively users 26) to post, fund, respond, accept, disbursement, and record feedback for the information exchange transaction using database 14 and feedback block 24 on electronic information exchange platform 28 executing on computer system 10.

Electronic information exchange agent 12 maintains unique data structure 30 in database 14, as shown in FIG. 2, to facilitate and optimize the information exchange transaction between users 26 to enhance the function, operation, and efficiency of computer system 10. There can be one or more data records in data structure 30 per information exchange transaction. Multiple exchanges between users 26 can create multiple data records in data structure 30. For example, a first question results in a first response and first data record, a follow-on second question results in a second response and second data record, and so on.

Data structure 30 includes an administrative field 34 for tracking information related to users 26, such as name, address, email, phone, expertise, and bank account. Request field 36 includes general subject matter, content of the request, time and date of submission, timeframe of response, confidentiality, additional considerations, and revision number. Funding field 38 includes amount or type of compensation, date of funding, compensation source or funding institution, requirements for disbursement of compensation, state of conditional transactions, and other comments or requirements of dispersing compensation. Response field 40-42 each include content of the response, time and date of submission, conditional statements, qualifying statements, and revision number. Response field 40-42 may be two separate responses from one provider 20, or responses from each of two providers 20-22. Acceptance field 44 includes time and date of acceptance by requester, confirmation of provider qualifications, conditional statements, and confirmation to disburse. Disbursement field 46 includes amount of disbursement, date of disbursement, disbursement source or institution, confirmation of requirements and conditions for disbursement, and administrative fees. Feedback field 48 includes feedback made by the requester relevant to the performance of the provider and quality, accuracy, and usefulness of the response. Feedback field 48 can be a Likert scale of fixed assessments and comment section for the requester, as well as a confirmation or rebuttal section for the provider.

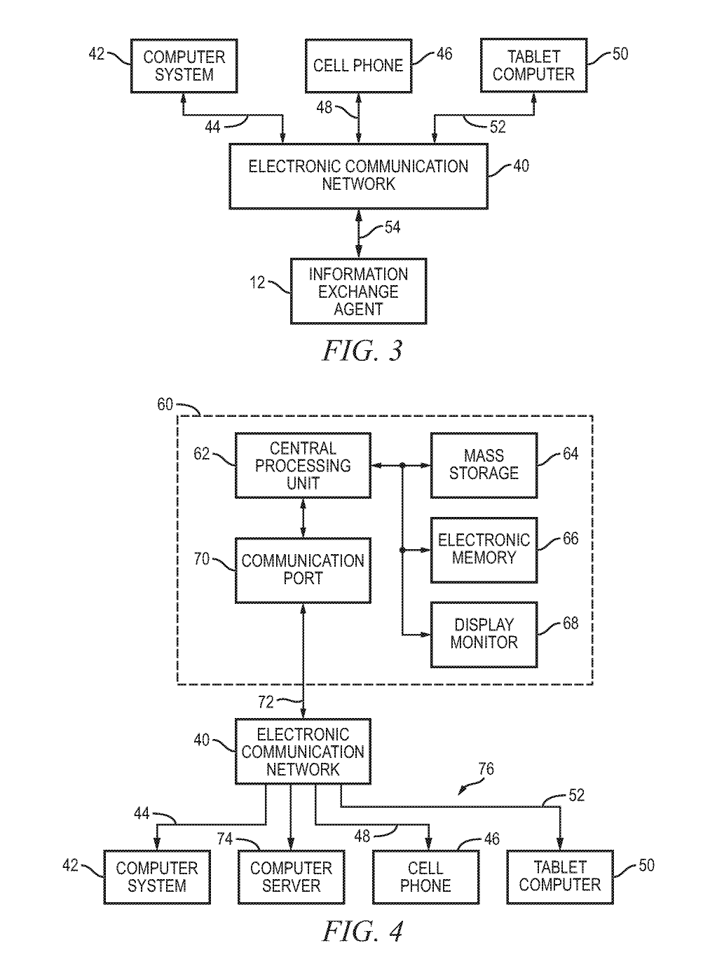

FIG. 3 shows an electronic communication network 40 for transmitting information between users 26 using one or more of computer system 42, cell phone 46, or tablet computer 50 to access electronic information exchange agent 12. Computer system 42 is connected to electronic communication network 40 by way of communication channel or link 44. Likewise, cellular telephone or smartphone 46 connects to electronic communication network 40 via communication link 48 and tablet computer 50 is connected to electronic communication network 40 by way of communication channel or link 52. Information exchange agent 12 operating on a computer server communicates with electronic communication network 40 over communication channel or link 54.

The electronic communication network 40 is a distributed network of interconnected routers, gateways, switches, and servers, each with a unique internet protocol (IP) address to enable communication between individual computers, cellular telephones, tablets, electronic devices, or nodes within the network. In one embodiment, communication network 40 is a global, open-architecture network, commonly known as the internet. In other embodiments, electronic communication network 40 includes a cell phone service network. Communication channels 44, 48, 52, and 54 are bi-directional and transmit data between computer system 42, cell phone 46, tablet computer 50, information exchange agent 12, and electronic communication network 40 in a hard-wired or wireless configuration. For example, computer system 42 has email, audio/video, and web browsing capability, and consumer cell phone 46 and tablet computer 50 have email, mobile applications (apps), audio/video, texting, and web browsing capability.

Further detail of the computer systems used in electronic communication network 40 is shown in FIG. 4 as a simplified computer system 60 for executing software programs used in the electronic communication process. Computer system 60 is a general-purpose computer including a central processing unit (CPU) or microprocessor 62, mass storage device or hard disk 64, electronic memory or RAM 66, display monitor 68, and communication port 70. Data records in data structure 30 can be stored in mass storage device 64 and/or electronic memory 66 and organized to facilitate and optimize the information exchange transaction between users 26 and enhance the functionality, operation, and efficiency of computer system 10. Communication port 70 represents a modem, high-speed Ethernet link, wireless, or other electronic connection to transmit and receive data over communication link 72 to electronic communication network 40. Computer system 42 and computer server 74 are configured similar to, and include similar internal components as, computer 60. Cell phone 46 and tablet 50 include related components as computer system 60, although commonly run different operating systems, software, and include smaller parts and packaging. Computer systems 42 and 60, computer server 74, cell phone 46, and tablet computer 50 (collectively referenced as devices 76) transmit and receive information and data over electronic communication network 40.

Devices 76 are physically located in any location with access to a modem or communication link to network 40. For example, devices 76 are located in a home or business office, a facility of information exchange agent 12, or are mobile and accompany the user to any convenient location, e.g., remote offices, consumer locations, hotel rooms, residences, vehicles, public places, or other locales with wired or wireless access to electronic communication network 40. Some devices 76 are carried with the individuals and operate with mobile apps.

Devices 76 run application software and computer programs, which are used to display user interface screens, execute the functionality, and provide the electronic communication features as described herein. The application software includes an internet browser, local email application, mobile apps, word processor, spreadsheet, audio/video feature, application programming interface (API), and the like. In one embodiment, the screens and functionality come from the application software, i.e., the electronic communication runs directly on devices 76. Alternatively, the screens and functions are provided remotely from one or more websites and webpages on servers connected to electronic communication network 40.

In one embodiment, electronic information exchange agent 12 includes an API accessed by users 26. Users 26 enter data directly using the API, or through websites and applications connected to electronic information exchange agent 12 via the API. An API facilitates the request and retrieval of information on behalf of a software program or application. An API is a set of commands, functions, and protocols, which programmers or developers use when building software for a specific operating system or application. An API allows programmers to use predefined functions to interact with an external application or computer system.

An API allows a software application to communicate with another applications running on a remote server over the internet using a series of API calls. With APIs, calls back and forth between applications are managed through web services. Web services are a collection of technological standards and protocols, including XML (Extensible Markup Language), a programming language by which applications communicate over the internet. An API call can comprise software code written as a series of XML messages. Each XML message corresponds to a different function of the remote service. For example, in a conferencing API, there are XML messages that correspond to each element required to schedule a new Web conference. Those elements include the conference time, the organizer's name and contact information, the invitees, and the duration of the conference.

By providing a means for requesting program services, an API can grant access to or open an application as an interface, defining the way in which separate entities or applications communicate. In some cases, software developers analogize APIs as “doors”, or “gateways,” that enable communication between different applications. APIs provide flexible yet controlled access to the data of an external computer system. The value of existing programs can be multiplied because content of the existing applications can be re-used, accessed, or exploited using APIs. Users 26 communicate with a web browser plugin connected to electronic information exchange agent 12 via an API to allow interaction between the users.

The software is originally provided on computer readable media, such as compact disks (CDs), digital versatile disks (DVDs), flash drives, and other optical media or mass storage medium. Alternatively, the software is downloaded electronically, such as from a host or vendor website. The software is installed onto the computer system mass storage 64 and/or electronic memory 66, and is accessed and controlled by the computer operating system. Software updates are also available on mass storage medium or downloadable from the host or vendor website. The software, as provided on the computer readable media or downloaded from electronic links, represents a computer program product containing computer readable program code embodied in a non-transitory computer program medium. Devices 76 execute instructions of the application software utilizing data structure 30 for communication between users 26 and electronic information exchange agent 12 to enable and administrate the exchange of information. Cell phone 46 or tablet computer 50 runs one or more mobile apps to execute instructions for communication between users 26 and electronic information exchange agent 12, which enables and administrates the exchange of information. The application software is an integral part of the control of electronic information exchange activity within enhanced computer system 10.

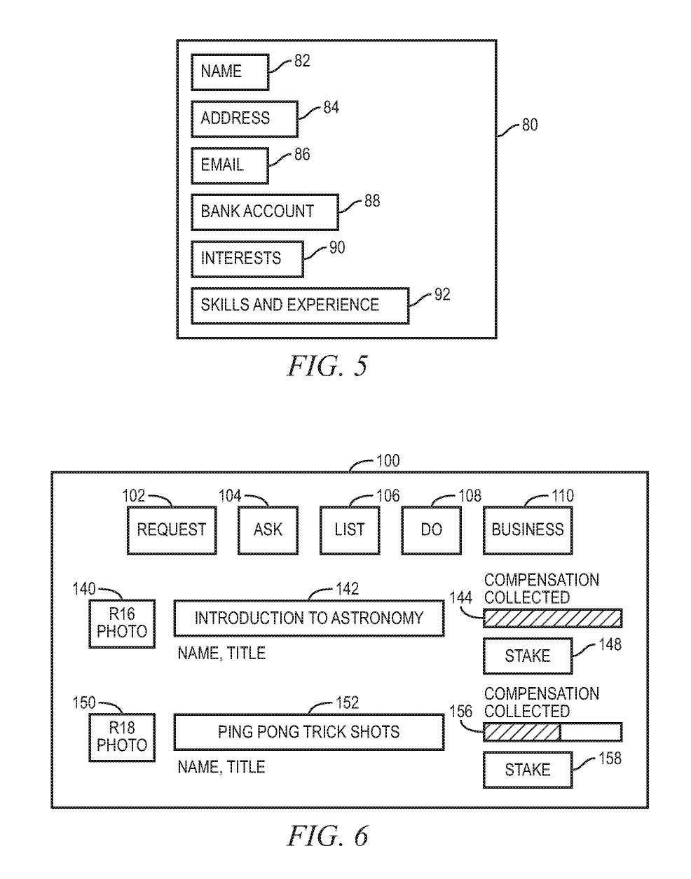

To interact with electronic information exchange agent 12, user 26 creates an account and profile with the information exchange agent. Full access requires completion of a registration process. User 26 accesses webpage 80 operated by information exchange agent 12 on electronic information exchange platform 28 and provides data to complete the registration and activation process, as shown in FIG. 5. The data provided by user 26 to electronic information exchange agent 12 includes name in block 82, address in block 84, email address in block 86, bank account/credit card in block 88, interests in block 90, skills and experience in block 92, and other information and credentials, such as date of birth, occupation, education, phone number, photo, title, social links, and associations, necessary to establish a profile and identity for the user. User 26 agrees to the terms and conditions of conducting electronic communication through information exchange agent 12.

The user's profile is stored and maintained within database 14. User 26 can access and update his or her profile or interact with electronic information exchange agent 12. The user's profile and personal data remains secure and, where appropriate, confidential within electronic information exchange agent 12.

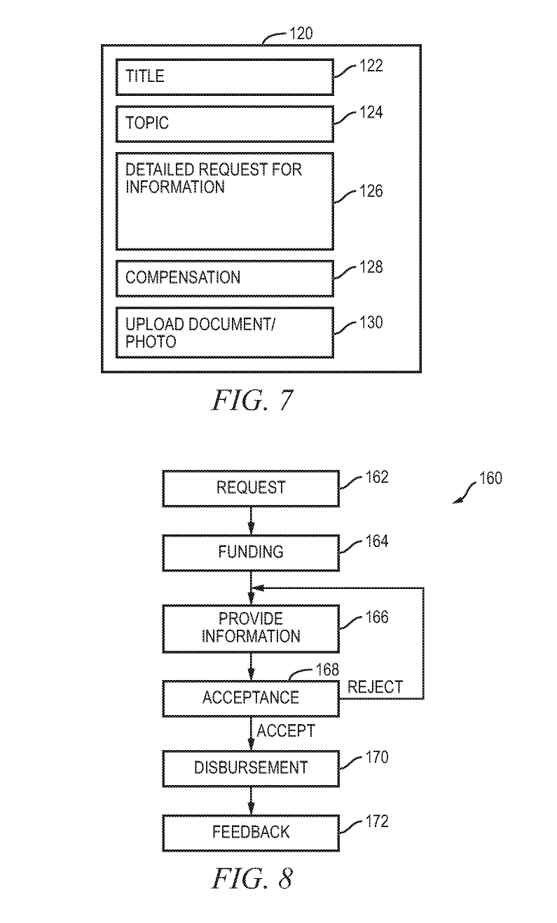

Once user 26 has logged-in to electronic information exchange agent 12, the user is presented with a home page to launch a variety of operations and functions using one or more webpages, menus, and features to facilitate the exchange of information between the users. FIG. 6 illustrates users 26 in communication with information exchange agent 12 on electronic information exchange platform 28 by electronic network 40 using devices 76 to access home webpage 100 with functions of request 102, ask 104, list 106, do 108, and business 110. In a first example, requester 16 selects request 102 to post a request for information. Webpage 120 in FIG. 7 shows further detail of entering a specific request. Webpage 120 allows requester 16 to specify a title in block 122, topic in block 124, detailed description of the information request in block 126, and offer by requester 16 to compensate for the information in block 128. Compensation can be a dollar amount, security, property, service, barter, or any other form of value or quid-pro-quo. Compensation can be a fixed fee or value based on duration or time of the response, e.g., dollars per minute of response. Requester 16 can upload photos, diagrams, or other documents relevant to the request for information in block 130. In one example, requester 16 enters a request for an introduction to astronomy.

Returning to FIG. 6, requester 16 (R16) photo 140 is shown with request 142 for “introduction to astronomy.” Requester 16 name and title are also shown below request 142. In order to get accurate and reliable information in response to request 142, requester 16 is willing to compensate for the answer or information sought by the request. Compensation collected 144 initially shows how much requester 16 is willing to compensate for request 142, e.g. dollars offered for request. Stake 148 allows other users 26 to contribute to compensation collected 144 to reach or exceed the total compensation for provider 20 or 22.

In a second example, requester 18 selects request 102 to post a request for information. Requester 18 uses webpage 120 to enter specifics of the request for information, i.e., a request for ping pong trick shots. Requester 18 (R18) photo 150 is shown in FIG. 6 with request 152 for “ping pong trick shots.” Requester 18 name and title are also shown below request 152. In order to get accurate and reliable information in response to request 152, requester 18 is willing to compensate for the answer or information sought by the request. Compensation collected 156 initially shows how much requester 18 is willing to compensate for request 152, e.g. dollars offered for the request. Stake 158 allows other users to contribute to compensation collected 156 to reach or exceed the total compensation for provider 20 or 22.

FIG. 8 illustrates a process flow of electronic information exchange transaction 160 on electronic information exchange platform 28 using data records in data structure 30. Requests 142 and 152 are represented by request block 162. Compensation collected 144 and 156 are represented by funding block 164 in FIG. 8. Funding 164 is held in an account recorded in database 14 to be available for disbursement upon acceptance of the information provided in information exchange transaction 160. In one embodiment, funding 164 is held as an authorization to charge a credit card, disperse funds on account, or transfer funds from a bank account.

Electronic information exchange agent 12 identifies providers 20-22 with skills, expertise, or experience relevant to request 142, as provided during registration in block 92, or identified by other transactions. Electronic information exchange agent 12 forwards request 142 and request 152 to providers 20-22 having the requisite background and knowledge. Electronic information exchange agent 12 may also post request 142 and request 152 to unregistered users and other users who might still have the requisite skills, expertise, or experience in the topic area. In the first example for request 142, provider 20 responds with a willingness to provide an introduction to astronomy and accepts the compensation offered by requester 16.

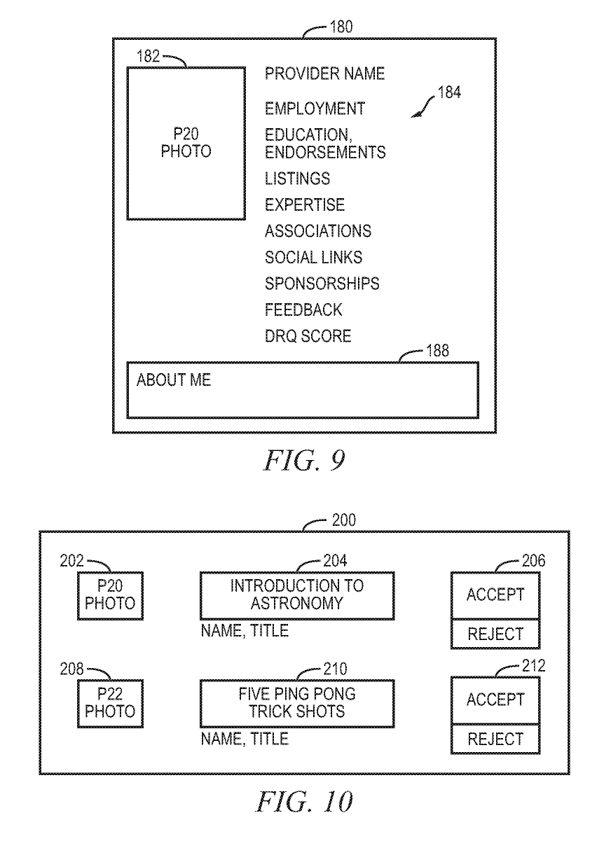

A profile of provider 20 (P20) is available on webpage 180 in FIG. 9, including P20 photo 182 and relevant information 184 related to his or her skills, experience, and expertise. Provider information 184 includes employment, education, endorsements, awards, listings, website interactions, expertise, associations, social links, sponsorships, and feedback. All or part of information is used to create a dynamic rating quantifier (DRQ) score. Each element of the DRQ score can have its own weighting factor. For example, employment is weighted 0.5, education is weighted 0.8, endorsements are weighted 0.3, awards is weighted 1.5, and so on. The DRQ score can be represented as a number, label, color, stars, or other symbol meaningful and recognizable to other users 26. A DRQ less than 50 may be considered a “novice or enthusiast” in a particular area, while a DRQ greater than 500 may be considered an “expert” in the area, and a DRQ greater than 1000 is considered a “legend” in the area. The association of the provider can be important to establishing a standard of competency. Membership in a recognized and respected association provides a higher DRQ score. The association may be independent or external, e.g. National Strength and Conditioning Association, or user 26 can create an association on electronic information exchange platform 28 and, by their reputation and acceptance of members, endorse other users. User 26 can receive an immediate DRQ score by nature of his or her resume or prior experience, even before participating in electronic information exchange transactions 160. In certain types of requests or contests involving requests and asks, user 26 with a high DRQ score are given more votes, weight of comments, or other responsive influence. If users 26 are conducting a contest for “Most influential contribution to genetics in the last year”, user 26 with a legend-level DRQ score (Nobel prize in physiology) is given more voting influence or weight of response to the contest by nature of the greater knowledge base on the relevant subject matter as evidenced by the DRQ score. About me block 188 allows provider 20 to expand on or explain relevant information. Webpage 180 is useful for requester 16-18 to evaluate and decide to enter into information exchange transaction 160 with provider 20.

In the second example for request 152, provider 22 responds with a willingness to teach ping pong trick shots. Provider 22 can accept the compensation offered by requester 18, or state what compensation is desired, which may be more than what requester 18 has offered. If provider 22 wants more than initially offered, compensation collected 156 shows initial offer as a percentage of the total compensation desired by provider 22. Requester 18 can fund any remaining amount asked by provider 22, or requester 18 can see if other users 26 are willing to contribute and share the information. For example, requester 16 may also want to learn ping pong trick shots in request 152 and will fund the remaining amount for provider 22 by selecting stake 158. Stake 158 allows other users 26 to contribute to compensation collected 156 to reach or exceed the total compensation for provider 22. Any number of users 26 can stake request 152 and share the information provided by provider 22. In some cases, requester 18 may be unwilling to meet the compensation asked by provider 22, and other users may not stake the difference. The principles of supply and demand govern information exchange transaction 160. Requester 18 may offer more, provider 22 may accept less, but not every request is answered.

Depending on the amount of the stake, the totality of the information shared may differ. For example, requester 18 funded $80 for five ping pong trick shots. Provider 22 wants $100 for the five ping pong trick shots. Requester 16 stakes the remaining $20 to fully compensate provider 22 for the five ping pong trick shots. Requester 18 paid 80% of the total compensation and requester 16 paid 20% of the total compensation. Requester 16 may get the same information as requester 18, i.e., all five ping pong trick shots, or requester 16 may get a lesser number than all of the five ping pong trick shots, e.g., two of the five ping pong trick shots due to the lesser percent of total compensation. Accordingly, information exchange agent 12 may share information among requesters based on an amount or percent of contribution to the total compensation for the request.

Once request 142 is fully funded in compensation collected 144, by one or more requesters 16-18, provider 20 makes available the requested information, i.e., video on astronomy. Provider 20 may post a recorded video, post documents with photos, meet in-person with requesters 16-18, or otherwise provide the requested information in a manner acceptable, meaningful, and useful to the requesters. Depending on whether the requester is a participant in the respective information exchange transaction 160, webpage 200 in FIG. 10 shows provider 20 (P20) photo 202 and posted video 204 covering request 142 “introduction to astronomy.” Provider 20 name and title are also shown below video 204. Requester 16 reviews video 204 and either selects the accept option or reject option of the video in block 206. Again, depending on whether the requester is a participant in the respective transaction 160, webpage 200 shows provider 22 (P22) photo 208 and posted video 210 covering request 152 “ping pong trick shots.” Provider 22 name and title are also shown below video 210. Requester 18 reviews video 210 and either selects the accept option or reject option of the video in block 212.

In another embodiment, provider 20-22 offers the requested information in a direct, interactive session with requester 16-18, see FIG. 21b. The realtime session is conducted as an interactive live audio/video feed through electronic information exchange agent 12 to comply with all the procedures and fulfill the compensation arrangement. Requester 16-18 and provider 20-22 can view status of the session, such as name of participants, method of communication, state of session in process, duration of session, mute the communication, hide the video, and end the session. A realtime session can be one requester to one provider, multiple requesters to one provider, one requester to multiple providers, or multiple requesters to multiple providers.

Provide information block 166 in information exchange transaction 160 of FIG. 8 is representative of video 204 and video 210 in webpage 200. Requester 16 reviews video 204 and either selects the accept option or the reject option for the video in block 206, as represented by acceptance block 168 in information exchange transaction 160. If requester 16 rejects videos 204, then provider 22 is given an opportunity to revise the information to a state acceptable to the requester. If the requester rejects the revised information (second rejection) or the provider otherwise disagrees with the rejection of the information, then any user 26 associated with the disputed information exchange transaction can request a dispute resolution process. The dispute can be resolved between the requester and provider by mediation, arbitration, or other dispute resolution process. Since requesters 16 and 18 are both stakeholders, video 210 can be rejected with either requester. Again, provider 22 is given an opportunity to revise the information to a state or condition acceptable to the requesters.

Once video 204 is accepted, electronic information exchange agent 12 disperses the funds to provider 20 in disbursement block 170 of FIG. 8. Compensation held in account recorded in database 14 for disbursement is transferred to provider 20. Once video 210 is accepted, electronic information exchange agent 12 disperses the funds to provider 22. Compensation held in account recorded in database 14 for disbursement is transferred to provider 22. FIG. 11 shows disbursing of funds to provider 20-22 in block 220 and retaining or reserving an administrative fee for use of electronic information exchange agent 12 in block 222. Information exchange agent 12 retains or reserves an administrative fee, e.g., a flat fee or a percent of the compensation, to maintain operations of electronic information exchange platform 28, as well as reasonable profit margin.

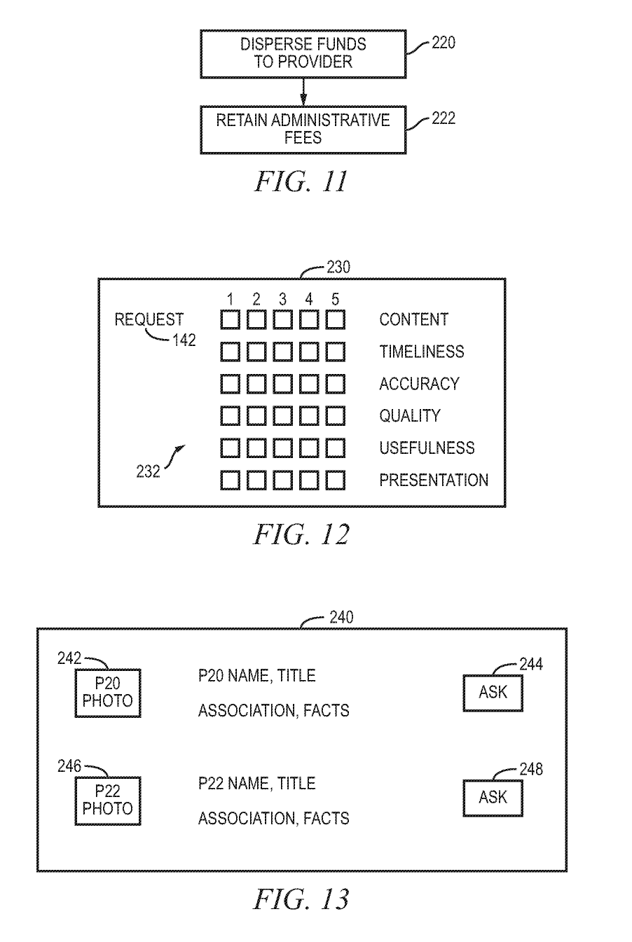

Requesters 16-18 can provide feedback 172 during information exchange transaction 160 in FIG. 8. Webpage 230 in FIG. 12 is an opportunity or option for requesters 16-18 to provide feedback 232 with respect to providers 20-22. There are varying degrees of acceptance, ranging from marginally acceptable to outstanding in presentation, content, and usefulness. For example, the information provided in response to request 142 is rated on content, timeliness, accuracy, quality, usefulness, and presentation, using a scale from 1-5 (1=lowest, 5=highest). Similar feedback 232 is collected for the information provided in response to request 152. Feedback 232 is stored in database 14 and made available to providers 20-22, as well as requesters 16-18, as a way of gauging prior information exchanges in consideration of future transactions. A provider that regularly exposes himself or herself to feedback and thrives is worthy of a high feedback rating, which will garner more confidence, respect, and willingness of requesters to meet their compensation for information. A provider with low feedback ratings will naturally fade from electronic information exchange platform 28 for the opposite reasons. Feedback 232 is an important measure of the provider's performance for optimal use and integrity of the system with accountability for all users 26.

The process of information exchange transaction 160 using the organization of data structure 30 in database 14 simplifies the function and operation of computer system 10 by storing the question and response in an efficient manner, as well as facilitating a compensation-based exchange of information to maintain the quality, accuracy, integrity, and accountability within electronic information exchange platform 28. The question and response format provides an organized, accurate, and efficient operation of computer system 10, as well as communication network 40. Electronic information exchange agent 12 monitors and regulates the connection between users seeking to exchange information. Requesters 16-18 asks a direct, specific, and unambiguous question. Providers 20-22 have relevant knowledge and experience on topic. The responses are compensated, with historical and objective feedback on individual responding users, so there is an expectation or accountability for true and accurate information.

Home webpage 100 in FIG. 6 provides another feature of electronic information exchange agent 12 on electronic information exchange platform 28, where requester 16 selects ask 104 to post a question to or request for information from a specific person, organization, entity, group, or everyone. The requester may want to ask a question from an expert, athlete, organization, or other person or entity that is otherwise hard to reach or inaccessible to the general public. For example, requester 16 wants to ask a question of provider 20, in this case a professional athlete. Webpage 240 in FIG. 13 shows provider 20 (professional athlete) with P20 photo 242 and name, title, association, and other relevant facts. Provider 20 can also be a group having a common association or attributes, e.g., all professional athletes on a given sports team. Ask block 244 allows requester 16 to ask a question specifically directed to provider 20. Webpage 240 also shows provider 22 (local zoo) with P22 photo 246 and name, title, association, and other relevant facts. Provider 22 can also be a group having a common association or attributes, e.g., all zoos in the United States. Ask block 248 allows requester 16 to ask a question specifically directed to provider 22. In each case, requester 16 is able to ask a question specifically directed to a person, organization, entity, or group that would otherwise be hard to reach or inaccessible by traditional avenues. Requester 16 likely pays a fee or otherwise provides compensation to get the attention of provider 20-22 and receive an answer to the question. Again, compensation can be dollar amount, security, property, service, barter, or any other form of value or quid-pro-quo. Compensation can be a fixed fee or value based on time of the response, e.g., dollars per minute of response. Requester 16 can also direct the question to everyone with qualifiers. For example, requester 16 can also direct the question to everyone with a particular physical abnormality or condition, or everyone who owns a particular vintage automobile.

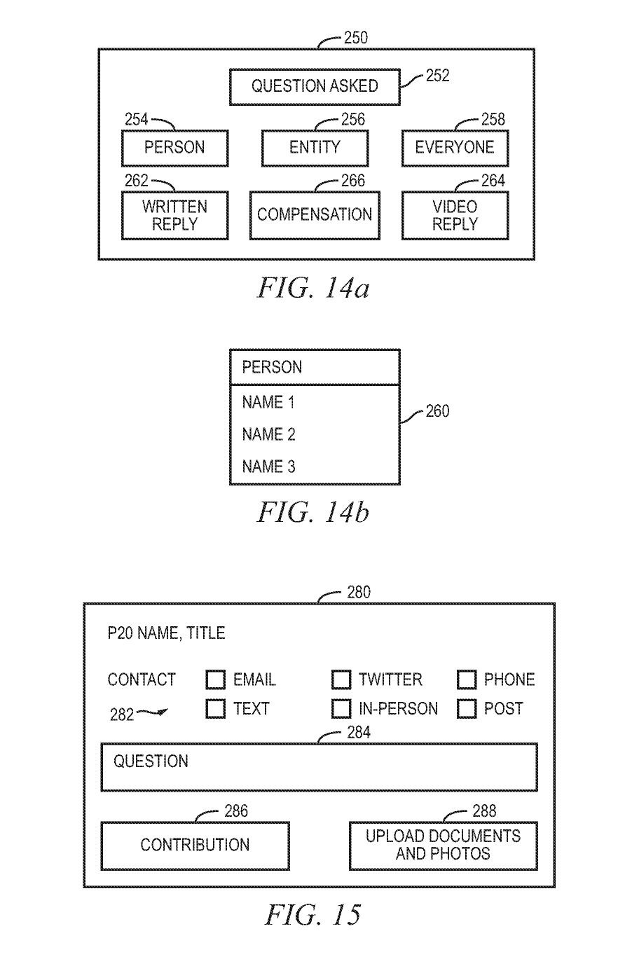

Webpage 250 in FIGS. 14a-14b illustrate an alternate presentation of ask 104. In FIG. 14a, requester 16 specifies the question being asked in block 252 and then selects person block 254, entity block 256, or everyone block 258, depending on the target audience. A pull-down menu 260, as shown in FIG. 14b, is overlaid on webpage 250 to select the specific person, entity, or qualifiers for everyone depending on the selected block 254-258. For example, selecting person block 254 overlays pull-down menu 260 with name1, name2, name3, and so on. Alternatively, selecting entity block 256 overlays pull-down menu 260 with entity1, entity2, entity3, and so on. Selecting everyone block 258 overlays pull-down menu 260 with qualifiers or attributes of the group or general population, e.g., everyone who participates in marathons. Requester 16 can type in the intended target name or portion thereof. Information exchange agent 12 populates pull-down menu 260 with names matching the given name portion. Requester 16 can also select the type of reply to the question in written reply block 262 or video reply block 264. In each case, requester 16 is able to ask a question specifically directed to a person, organization, or entity that would otherwise be hard to reach or inaccessible by traditional avenues. As with similar features of electronic information exchange agent 12, requester 16 provides suggested compensation for the reply to the question in compensation block 266.

Requester 16 can also ask the same question of different providers 20-22 known to have alternate views or differences of opinion. The process naturally versus one point of view from another point of view. The responses from both providers 20-22 can be entertaining and informative.

Continuing from FIG. 13, requester 16 can specify particulars of the question on webpage 280 in FIG. 15, such as select mode of contact 282 as email, twitter, phone, text, in-person, or post. Requester 16 states the question in block 284 to provider 20 (professional athlete), e.g., “What role did your parents play in your development as an athlete?”, and makes a contribution in block 286. In order to get accurate and reliable information in response to question 284, requester 16 is willing to compensate for access to provider 20, as well as the answer to the question sought by the request. Requester 16 can upload photos, diagrams, or other documents relevant to the question in block 288.

Information exchange agent 12 contacts provider 20-22 with the question from requester 16. Provider 20-22 can decide whether to respond and answer the question for a variety of reasons, including the compensation offered in block 286. Provider 20 answers question 284 or makes available the requested information. Provider 20 may post a statement or video, meet in-person with requesters 16-18, or otherwise answer the question or provide the requested information in a manner acceptable and meaningful to requester 16, consistent with mode of contact 282. Sometimes the question being asked requires a simple “yes” or “no” answer. For example, requester 16 asks the professional athlete “Will you attend my son's birthday party?” The answer will likely be a simple yes or no. Ask 102 is another type of electronic information exchange transaction 160.

Another question that requester 16 can ask of a specific organization (business) is can I purchase a particular product at a reduced price. Requester 16 specifies the product and offers a price or asks for a discount. The business can accept the offered price or counter-offer and agree to options, such as size, color, and extended warranty. The information exchange transaction remains available on electric information exchange agent 12 for other users 26 to participate and get the same product at the same price, or a related product for a discounted price.

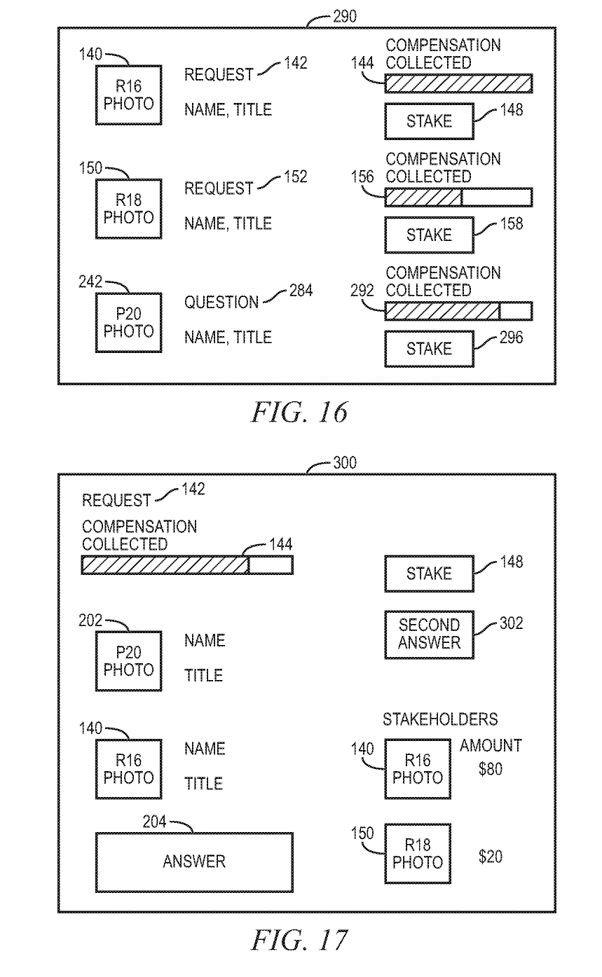

As another feature from home webpage 100 on electronic information exchange platform 28 in FIG. 6, requester 16 selects list 106 to see a listing of pending and completed information exchange transactions 160. The list of pending and completed information exchange transactions 160 may be extensive so user 26 can sort by listing title, topic, provider, on-line status, language, and price range. Webpage 290 in FIG. 16 allows user 26 to view or list request 142 “introduction to astronomy”, request 152 “ping pong trick shots”, and question 284 “What role did your parents play in your development as an athlete?”. Webpage 290 also shows R16 photo 140, name and title, compensation collected 144, stake 148, R18 photo 150, name and title, compensation collected 156, and stake 158, P20 photo 242, and name and title. Compensation collected 292 for question 284 starts with contribution 286 and may increase by other users 26 making stake 296 to also see P20's response to the question.

Webpage 300 in FIG. 17 shows further detail of one particular listing of request 142 with compensation collected 144, P20 photo 202 with name and title (answering provider), R16 photo 140 with name and title (original requester), answer 204 from provider 20, stake 148, and stakeholders with individual contributions to compensation collected. Other providers can provide an alternate answer to request 142 in answer block 302.

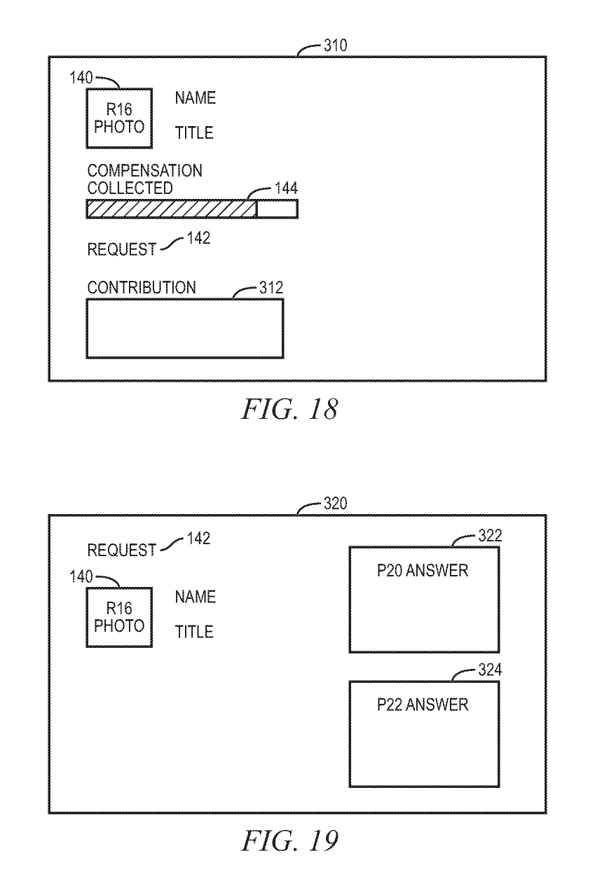

Webpage 310 in FIG. 18 shows further detail of making a stake in a pending request or ask, including compensation collected 144, R16 photo 140 with name and title (original requester), and stakeholder's contribution to compensation collected in block 312. If requester 18 makes a contribution to the total compensation of compensation collected 144, then he or she becomes a stakeholder in request 142 and the contribution shows up in compensation collected 144.

Electronic information exchange agent 12 allows multiple providers to respond to the same request, e.g., providers 20 and 22 both respond to request 142. Webpage 320 in FIG. 19 shows a scenario where multiple providers choose to answer a request for information. In this case, requester 16 posts request 142. Provider 20 answers request 142 with P20 answer 322. Provider 22 answers request 142 with P22 answer 324. Requester 16 has the option of selecting either or both responding providers. Requester 16 may choose to compensate both providers 20 and 22, or compensate the provider with the best answer. In another embodiment, requester 16 formats request 142 as a contest for responses among multiple providers. The responses to the contest can be judged by requester 16 or more generally by users 26 or specific group of users.

Alternatively, multiple requesters may make the same or similar request, e.g., requesters 16 and 18 both make request 142. Electronic information exchange agent 12 can link similar requests where appropriate and acceptable by the requesters. Requesters 16 and 18 can choose to combine compensation and accept a common response. Provider 20 may respond to requesters 16 and 18 separately or collectively, depending on the nature of request and other circumstances. Electronic information exchange agent 12 makes the overlap between requests and responds transparent to users 26 and honors any requested confidentiality provisions.

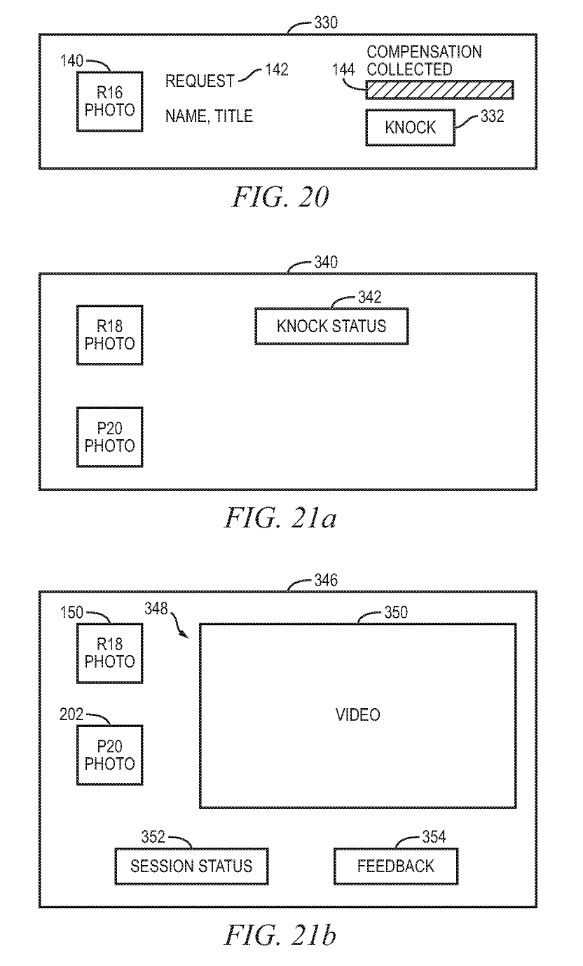

Webpage 330 in FIG. 20 illustrates a knock feature on electronic information exchange platform 28 where a requester identifies a request of interest and “knocks” for permission to engage a realtime session on the subject. Requester 18 selects knock 332 to engage a session from provider 20 on request 142 “introduction to astronomy” previously used by requester 16. Provider 20 is notified through electronic information exchange agent 12 that requester 18 wants a one-on-one session on request 142. If provider 20 is available, the session is engaged and requester 18 communicates directly in realtime with provider 20 on introduction to astronomy. Otherwise, requester 18 and provider 20 can agree to schedule a later time, say an hour later, for the session on request 142. When the scheduled time arrives, requester 18 and provider 20 start the session and communicate directly in realtime on the introduction to astronomy.

Webpage 340 in FIG. 21a illustrates knock 332 between requester 18 with R18 photo 150 and provider 20 with P20 photo 202 on electronic information exchange platform 28. Requester 18 and provider 20 can view status of knock 332, such as knock queued, waiting, ready, started, ended, or cancelled in knock status 342. Knock 332 supports multiple participant combinations. A realtime session can be one requester to one provider, multiple requesters to one provider, one requester to multiple providers, or multiple requesters to multiple

Webpage 346 in FIG. 21b illustrates direct, interactive session 348 in process between requester 18 with R18 photo 150 and provider 20 with P20 photo 202 on electronic information exchange platform 28. The realtime, interactive session 348 is visible on video block 350. Requester 18 and provider 20 can view status of session 348, such as method of communication, state of session in process, start time, duration of session, mute the communication, hide the video, and end the session, in session status 352. Requester 18 provides feedback for provider 20 following session 348 in feedback block 354, as described for webpage 230 in FIG. 12.

Knock 332 enables a connection between the requester and provider under the procedures of electronic information exchange agent 12. The session is typically compensated by requester 18. In order to maintain confidentiality and manage the compensation, requester 18 and provider 20 typically do not fully engage in communication until the session actually begins. If provider 20 does not respond to the knock in a short period of time (1-5 minutes), the knock expires.

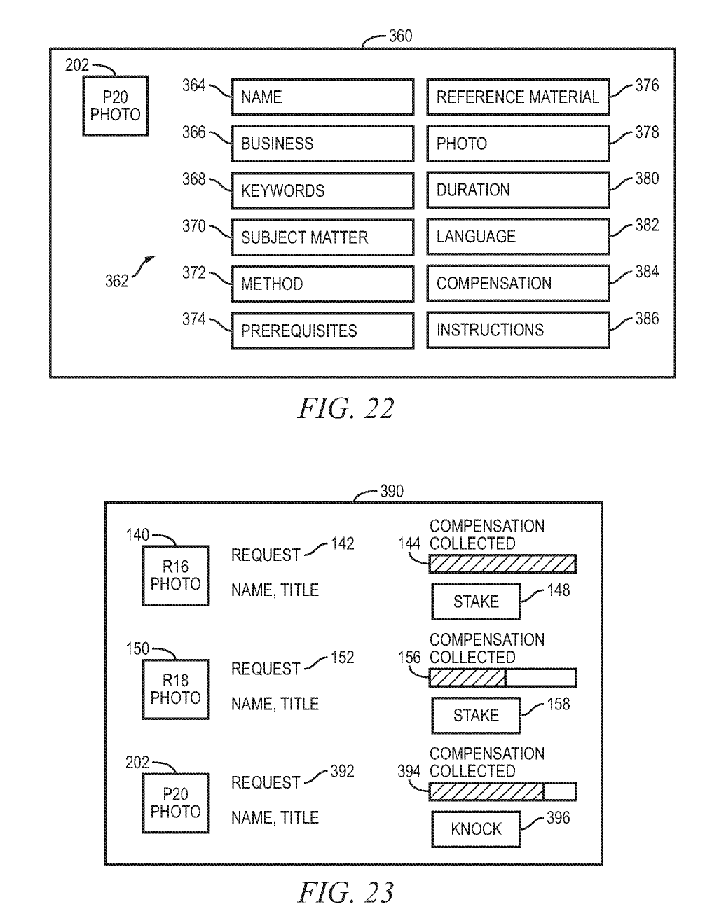

Provider 20-22 can create the opportunity for a session without receiving a prior specific request from requester 16-18. Webpage 360 in FIG. 22 illustrates provider 20 creating an available session 362 of his or her own choosing (without prior request) for math tutoring on electronic information exchange platform 28. Provider 20 with P20 photo 202 creates name 364 for the session, associated business information 366, keywords 368 to find the available session with a search, subject matter 370 proposed for the session, method of conducting the session 372, prerequisites 374, reference materials or tools 376, representative photo 378, duration 380 of the session, language 382 to be used during the communication, compensation 384, and other instructions 386. Requester 18 finds the available session 362 of interest and knocks to engage the session. Requester 18 and provider 20 are connected through electronic information exchange agent 12, as described for webpage 330. Requester 18 provides feedback for provider 20 following the session, as described for webpage 230 in FIG. 12.

As another feature from home webpage 100 on electronic information exchange platform 28 in FIG. 6, user 26 selects do 108 to create a list of areas of interest or activities to do. Webpage 390 in FIG. 23 allows user 26 to view or add to their personal to-do list. For example, user 26 has as interest in request 142 “introduction to astronomy”, request 152 “ping pong trick shots”, and request 392 “learn Spanish”. Webpage 390 also shows R16 photo 140, name and title, compensation collected 144, stake 148, R18 photo 150, name and title, compensation collected 156, and stake 158, P20 photo 202, compensation collected 394, and knock 396. User 26 can keep track of current to-do list and remove as completed.

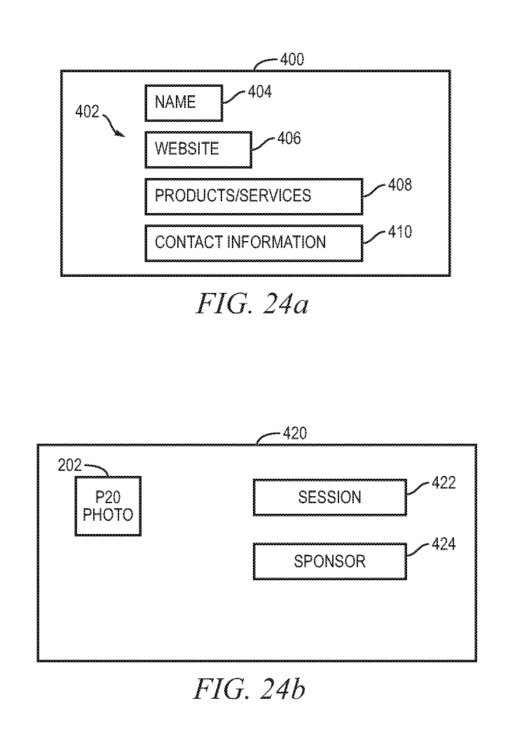

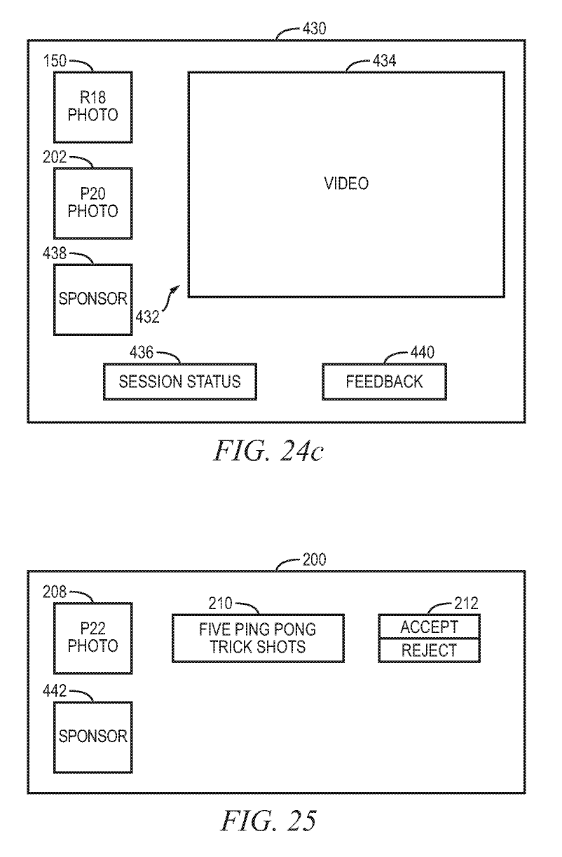

As another feature from home webpage 100 on electronic information exchange platform 28 in FIG. 6, user 26 selects business 110 to establish or create a sponsorship for one or more information exchange transactions 160, including specific sessions created by providers. Webpage 400 in FIG. 24a shows business 402 providing registration or membership information, including name of business 404, business website 406, products or services 408, and contact information 410. Business 402 can be any type of commercial entity, non-profit organization, government agency, social organization, or other group wanting to sponsor the exchange of information on electronic information exchange platform 28. A sponsorship is useful for business 402 to establish good-will, brand recognition, and advertise products and services. Business 402 provides the compensation for the providers to conduct sessions for the requesters. Business 402 compensates the provider for each session (by money, merchandise, rewards, credits, incentives, point system toward money or rewards, VIP status, DRQ score). Business 402 retains control of the provider being offered the sponsorship, type of sessions, number of sessions, and even which requesters (by profile or demographics) that are allowed to participate. Business 402 wants to provide sponsorships to qualified providers, who will offer sponsored sessions to those requesters that are potential customers. Users 26 appreciate the business sponsorship, particularly when the requesters do not have the means to provide compensation, or otherwise decline the opportunity to participate in information exchange transaction 160 for financial reasons. Providers offering sessions will have more users participating with sponsorships allowing free or reduced fee sessions. Electronic information exchange agent 12 collects a fee from business 402 for the sponsorships.

In one example, provider 22 wants to offer ping pong training sessions and gains the sponsorship of business 402, which markets ping pong paddles. Provider 22 may lobby business 402 for a sponsorship, or the business may recruit the provider. Provider 22 becomes a liaison or representative of business 402 and will endorse or market its products or services by nature of conducting the session in a manner favorable to the business. Business 402 manages the liaison provider 22 to ensure effective use of its marketing budget and positive presentation of its products or services.

Webpage 420 in FIG. 24b shows P20 photo 202 and session offering 422 for ping pong training sessions with sponsorship 424. Requester 18 selects session offering 422. Webpage 430 in FIG. 24c illustrates direct, interactive session 432 in process between requester 18 with R18 photo 150 and provider 20 with P20 photo 202 on electronic information exchange platform 28. The realtime, interactive session 432 is visible on video block 434. Requester 18 and provider 20 can view status of session, such as method of communication, state of session in process, start time, duration of session, mute the communication, hide the video, and end the session, in session status 436. In particular, business 402 is presented in sponsor block 438 with its logo, products, or services during the entire session 432. Sponsor block 438 may have a photo advertising one model of the ping pong paddle manufactured by business 402. Requester 18 can select sponsor block 438 to get additional information about business 402, as well as its products or services, e.g., by linking to website 406 for the requester to consider its ping pong paddles. Business 402 may provide free merchandise or other discounts and rewards to requester 18 for selecting sponsor block 438. If requester 18 makes a purchase from business 402 via sponsor block 438, provider 22 may receive a share of the profit from the business. In fact, any user 26, whether a requester, provider, or stakeholder, can receive a share of the profit or ad revenue from the business depending on their contribution that lead to the sale. For example, a requester can be compensated for making a request that leads to a popular transaction and generates significant exposure and sales for the business. Electronic information exchange agent 12 also receives a fee from business 402 for requester 18 clicking through on sponsor block 438. By sponsoring session 432, business 402 gains good-will, brand recognition, and advertisements for its products and services. Requester 18 provides feedback for provider 20 following session 432 in feedback block 440, as described for webpage 230 in FIG. 12.

Business 402 may elect to stake certain pending requests being processed by electronic information exchange agent 12. In one example, business 402 elects to stake 158 in FIG. 6. In this case, staking request 152 allows business 402 to post sponsor block 442 on webpage 200, as shown in FIG. 25. Sponsor block 442 shows a logo, products, or services of business 402 during presentation of video 210 for five ping pong trick shots. Requester 18 can select sponsor block 442 to get additional information about business 402, as well as its products or services, e.g., by linking to website 406 for the requester to consider its ping pong paddles. Business 402 may provide free merchandise or other discounts and rewards to requester 18 for selecting sponsor block 442. If requester 18 makes a purchase from business 402 via sponsor block 442, provider 22 may receive a share of the profit from the business. Electronic information exchange agent 12 also receives a fee from business 402 for requester 18 clicking through on sponsor block 442. Business 402 gains good-will, brand recognition, and advertisements for its products and services by making stake 158 and sponsoring request 152.

The process of information exchange transaction 160 using the organization of data structure 30 in database 14 simplifies the function and operation of computer system 10 by storing the question and response in an efficient manner, as well as facilitating a compensation-based exchange of information to maintain the quality and integrity of the system. The question and response format provides an organized, accurate, and efficient operation of computer system 10, as well as communication network 40. Information exchange transaction 160, including session offerings 422, can be sponsored for the benefit of users 26 and business 402. Electronic information exchange agent 12 monitors and regulates the connection between users seeking to exchange information. Requesters 16-18 asks a direct, specific, and unambiguous question. Providers 20-22 have relevant knowledge and experience on topic. The responses are compensated, with historical and objective feedback on individual responding users, so there is an expectation or accountability for true and accurate information.

While one or more embodiments of the present invention have been illustrated in detail, the skilled artisan will appreciate that modifications and adaptations to the embodiments may be made without departing from the scope of the present invention as set forth in the following claims.

What is claimed:

1. A method of controlling communication over an electronic network to facilitate an exchange of information, comprising:
providing a database on a first computing system including a data structure to organize records for the exchange of information;
providing an electronic information exchange agent on the first computing system;
providing a request for information from a first user on a second computing system to the electronic information exchange agent on the first computing system, wherein the request for information includes an offer of compensation for a response to the request for information;
storing the request for information in the data structure on the first computing system;
providing the response to the request for information from a second user on a third computing system to the electronic information exchange agent on the first computing system;
storing the response in the data structure on the first computing system; and
providing the response to the first user and compensation to the second user to facilitate the exchange of information.

2. The method of claim 1, further including providing the first user an acceptance option or rejection option for the response to the request for information.

3. The method of claim 1, further including providing the first user a feedback option to evaluate the response to the request for information.

4. The method of claim 1, wherein the request for information includes a question directed to the second user.

5. The method of claim 1, further including reserving a portion of the compensation as an administrative fee for use of the electronic information exchange agent.

6. The method of claim 1, further including presenting a plurality of requests for information from a plurality of users.

7. A method of controlling communication over an electronic network to facilitate an exchange of information, comprising:
providing a database on a first computing system including a data structure to organize records for the exchange of information;
providing an electronic information exchange agent on the first computing system;
providing a request for information from a first user on a second computing system to the electronic information exchange agent on the first computing system, wherein the request for information is stored in the data structure;
providing a response to the request for information from a second user on a third computing system to the electronic information exchange agent on the first computing system, wherein the response is stored in the data structure; and
providing the response to the first user to facilitate the exchange of information.

8. The method of claim 7, wherein the request for information includes an offer of compensation for the response to the request for information.

9. The method of claim 8, further including providing the compensation to the second user to facilitate the exchange of information.

10. The method of claim 8, further including reserving a portion of the compensation as an administrative fee for use of the electronic information exchange agent.

11. The method of claim 7, further including providing the first user an acceptance option or rejection option for the response to the request for information.

12. The method of claim 7, further including providing the first user a feedback option to evaluate the response to the request for information.

13. The method of claim 7, wherein the request for information includes a question directed to the second user.

14. A non-transitory, tangible computer readable medium storing instructions for controlling communication over an electronic network, the instructions causing the electronic network to perform the steps, comprising:
providing a database on a first computing system including a data structure to organize records for the exchange of information;
providing an electronic information exchange agent on the first computing system;
providing a request for information from a first user on a second computing system to the electronic information exchange agent on the first computing system, wherein the request for information is stored in the data structure;
providing a response to the request for information from a second user on a third computing system to the electronic information exchange agent on the first computing system, wherein the response is stored in the data structure; and
providing the response to the first user to facilitate the exchange of information.

15. The non-transitory, tangible computer readable medium of claim 14, wherein the request for information includes an offer of compensation for the response to the request for information.

16. The non-transitory, tangible computer readable medium of claim 15, further including providing the compensation to the second user to facilitate the exchange of information.

17. The non-transitory, tangible computer readable medium of claim 15, further including reserving a portion of the compensation as an administrative fee for use of the electronic information exchange agent.

18. The non-transitory, tangible computer readable medium of claim 14, further including providing the first user an acceptance option or rejection option for the response to the request for information.

19. The non-transitory, tangible computer readable medium of claim 14, further including providing the first user a feedback option to evaluate the response to the request for information.

20. The non-transitory, tangible computer readable medium of claim 14, wherein the request for information includes a question directed to the second user.
